(19) United States
(12) Patent Application Publication
(10) Pub. No.: US 2007/0206546 A1
(43) Pub. Date: Sep. 6, 2007

(54) Method and apparatus for preventing denial of service attacks on cellular infrastructure access channels

(76) Inventors: William P. Alberth JR., Prairie Grove, IL (US); Daniel J. Declerck, Lake Barrington, IL (US); Gino A. Scribano, St. Charles, IL (US)

Correspondence Address: MOTOROLA INC, 600 NORTH US HIGHWAY 45, ROOM AS437, LIBERTYVILLE, IL, 60048-5343, US

(21) Appl. No.: 11/366,360

(22) Filed: Mar. 2, 2006

(51) Int. Cl. H04Q 7/24

(52) U.S. Cl. 370/338

(57) ABSTRACT

In the various embodiments, base station (103), or base station controller (101), will determine whether mobile station (107) is sending access requests beyond a limit predetermined to represent normal mobile station behavior. If the mobile station exceeds this limit, the network, via base station (103) or other base stations such as base station (105), will send a maintenance message to the mobile station (107) for the purpose of limiting its access requests. The maintenance message may comprise a parameter that specifies a limited number of access requests (109), (111) the mobile station (107) may make within a given time period. The mobile station (107) may still be allowed to send access requests (109) for the purpose of making an emergency call, and may further be limited to sending access requests only if the emergency call is placed from the mobile station (107) keypad.

### FIELD OF THE INVENTION

The present invention relates generally to wireless communications systems, and more particularly to wireless mobile devices accessing such communications systems.

### BACKGROUND OF THE INVENTION

As computer operating systems became standardized and prevalent in the marketplace, malicious code such as viruses began to propagate via the practice of file sharing or otherwise the practice of working on files using various computers. Networking and the Internet added complexity to the problem because of the ease with which infected files may be distributed across a vast number of computers within a short time period by traversing the network.

Wireless communications systems are beginning to employ wireless mobile device operating systems that are similar to those employed by computers in general. Therefore, along with the benefits of such standardized operating systems comes the threat of malicious code such as viruses.

Denial of service attacks have been suffered over the Internet by web sites and email servers, in some cases resulting in financial consequences to the businesses or individual users operating the servers or using the services.

With the utilization of Internet technologies and standardized operating systems, denial of service attacks may become a threat for wireless communications systems as well, which could result in many undesirable financial consequences and security issues. One potential user specific problem is that a virus infected mobile phone, if completely disabled due to a virus infection, would prevent the user from making an emergency call.

### BRIEF DESCRIPTION OF THE DRAWINGS

FIG. 1 is a block diagram of a wireless network.

FIG. 2 is a block diagram of a mobile station in accordance with the various embodiments.

FIG. 3 is a block diagram of a mobile station architecture having various application programming interfaces in accordance with the embodiments.

FIG. 4 is a flow chart illustrating basic operation in accordance with various embodiments.

FIG. 5 is a flow chart illustrating operation of a network control entity in accordance with the embodiments.

FIG. 6 is a flow chart illustrating operation of a mobile station in accordance with the embodiments.

FIG. 7 is a flow chart illustrating receiving and storing of authentication and integrity information by a wireless device.

FIG. 8 is a flow chart illustrating authenticity and integrity checks for a maintenance message received by a wireless device in accordance with some embodiments.

FIG. 9 is a flow chart illustrating authenticity and integrity checks for a patch received by a wireless device in accordance with some embodiments.

FIG. 10 is a flow chart illustrating further details of integrity checks by a wireless device using an integrity key in accordance with some embodiments.

### DETAILED DESCRIPTION

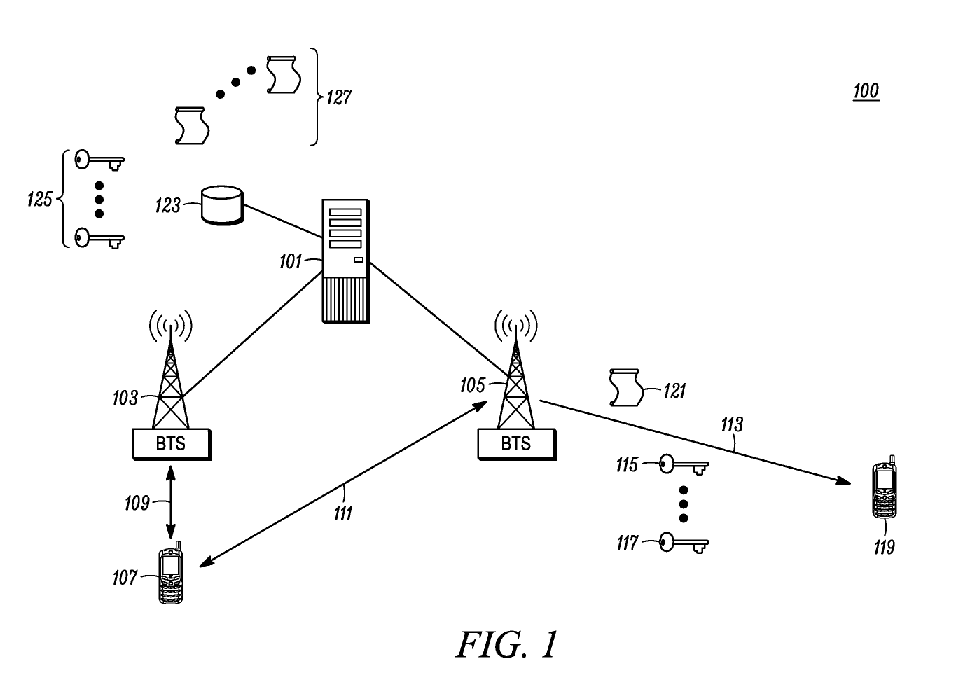

FIG. 1 illustrates a wireless network 100. Wireless network 100 comprises a number of base stations such as base stations 103 and 105 and a number of controller entities such as base station controller 101. Each base station controller may be connected to, and provide control over, one or more base stations. For example, in FIG. 1, base station controller 101 is connected to, and controls, base stations 103 and 105.

A mobile station 107 communicates with the base stations via any suitable air interface such as, but not limited to, GSM, CDMA, UMTS, etc. A mobile station may request access to a network using for example in some embodiments, a Random Access Control Channel (RACH). Under normal operating circumstances an access request message, for example message 109, will be transmitted to base station 103 to request access for placing a call. The base station 103 may then provide an access channel to mobile station 107 such that mobile station 107 may proceed to make a call.

The mobile station 107 will in general be able to communicate with several base stations within radio coverage. However, the mobile station will usually camp on the best serving base station, that is, the base station for which the radio signal strength, or some other signal quality indication or combination of indications, is best for the mobile station in a particular geographic location. As the mobile station travels, the best serving base station will change from time to time. For example, if mobile station 107 determines that base station 105 has become its best server then mobile station 107 would send an access request 111 to base station 105 if the mobile station user wishes to place a call.

The access request message, and likewise the granted access channel, both use resources of the air interface and thus resources of the base station. A large number of access requests could overload the base station such that some callers would be blocked from access to the network. Therefore, if an anomaly in the mobile station caused the mobile station 107 to send an excessive number of access requests to base station 103, for example, base station 103 may be prevented from receiving access requests from other mobile stations. The result would be a denial of service attack on the network base station, which could possible overload the base station controller 101 as well.

In the various embodiments, base station 103 will notice whether mobile station 107 sends access requests beyond a limit predetermined to represent normal mobile station behavior. If the mobile station exceeds this limit, the network, via base station 103 or other base stations such as base station 105, will send a maintenance message to the mobile station 107 for the purpose of limiting its access requests.

The base station controller 101 may in some embodiments further comprise, or be connected to, database 123. Database 123 stores various keys 125, such as integrity keys, and may also store authentication credentials 127. Keys 125 may also include various encryption keys for encrypting authentication credentials 127. A mobile station, for example mobile station 119, may receive one or more integrity keys 115, 117 and authenticity credentials 121 from the network via communication link 113, and store this information in a secured memory.

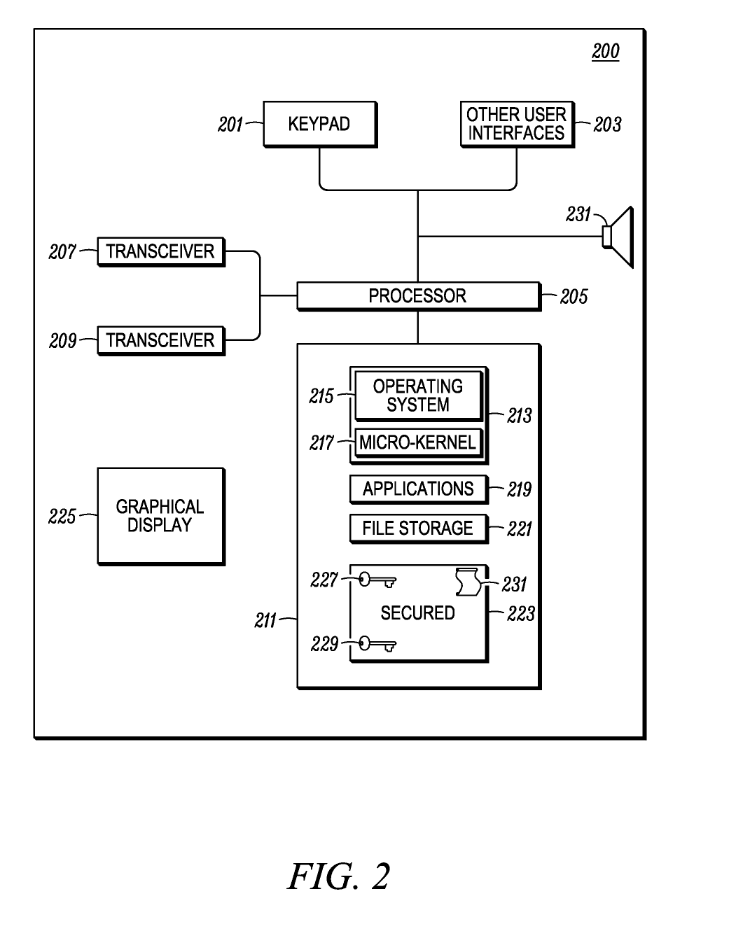

FIG. 2 is a block diagram illustrating the primary components of a mobile station in accordance with some embodiments. Mobile station 200 comprises a keypad 201, other user interfaces 203, at least one processor 205, and at least one memory 211. Memory 211 has storage sufficient for the mobile station operating system 213, applications 219 and general file storage 221. The memory 211 may further comprise a secured memory component 223 which may be integrated with memory 211 or may be a physically separate component in some embodiments. The secured memory 223 may store a number of keys, such as integrity keys 227 and 229, and may also store authenticity credentials such as certificate 231. Further, secured memory 223 may store a number of encryption keys.

Mobile station 200 user interfaces 203, may be a combination of user interfaces including, but not limited to, a touch screen, voice activated command input, and gyroscopic cursor controls. Mobile station 200 has a graphical display 225, which may also have a dedicated processor and/or memory, drivers etc. which are not shown in FIG. 2. Mobile station 200 further comprises audio speaker 231.

It is to be understood that FIG. 2 is for illustrative purposes only and is for illustrating the main components of a mobile station in accordance with the present disclosure, and is not intended to be a complete schematic diagram of the various components and connections therebetween required for a mobile station. Therefore, a mobile station may comprise various other components not shown in FIG. 2 and still be within the scope of the present disclosure.

Returning to FIG. 2, the mobile station 200 may also comprise a number of transceivers such as transceivers 207 and 209. Transceivers 207 and 209 may be for communicating with various wireless networks using various standards such as, but not limited to, GSM, IS-95 CDMA, UMTS, CDMA2000, 802.11, 802.16, etc.

Memory 211 is for illustrative purposes only and may be configured in a variety of ways and still remain within the scope of the present disclosure. For example, memory 211 may be comprised of several elements each coupled to the processor 205. Further, separate processors and memory elements may be dedicated to specific tasks such as rendering graphical images upon a graphical display, or for providing operating system security and data integrity. In any case, the memory 211 will have at least the functions of providing storage for an operating system 213, applications 219 and general file storage 221 for mobile station 200.

In some embodiments, operating system 213 may comprise a kernel or micro-kernel 217 which supports additional operating system 215. For example, operating system 215 may be Linux and micro-kernel 217 may be L4 in some embodiments. In any event, for the embodiments having micro-kernel 217, the micro-kernel 217 provides a root mode, or supervisory mode, wherein higher order software such as operating system 215, or segments of operating system 215, and applications 219, or portions of applications 219 may be removed leaving operating capabilities provided by micro-kernel 217 in tact.

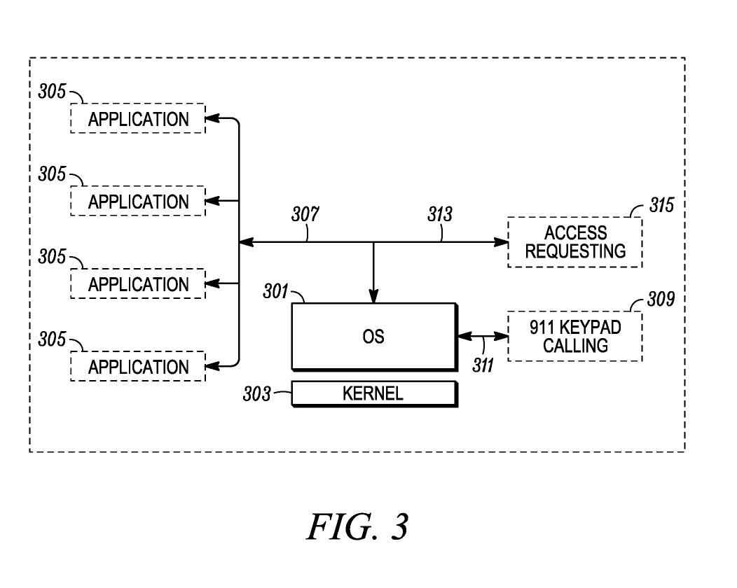

FIG. 3 illustrates a mobile station architecture in accordance with the embodiments. The mobile station has an operating system (OS) 301 and a secure kernel 303. The OS 301 communicates with a plurality of applications 305 via a corresponding plurality of application programming interfaces (APIs) 307. Among the plurality of applications and APIs, is the access requesting (AR) application 315 and its API 313, and simple keypad application 309 and keypad dialing API 311.

In the various embodiments, if the network detects an abnormal number of access requests send from a mobile station, the network will send a message causing the mobile station to reboot into a safe mode in which only keypad API 311 and keypad dialing application 309 are allowed to function. All other applications 305 and APIs 307 are disabled, specifically Access Requesting (AR) application 315 and AR API 313 are either disabled or limited to use only with keypad dialing application 309. In some embodiments the network message causing the mobile station to reboot may be an air interface physical layer indicator.

It is to be understood that applications 305, 309, and 315 may be, but are not limited to, object code, JAVA, Brew, Linux, Windows, HTML, WAP, script files including JavaScript, XML scripts, WML scripts, etc.

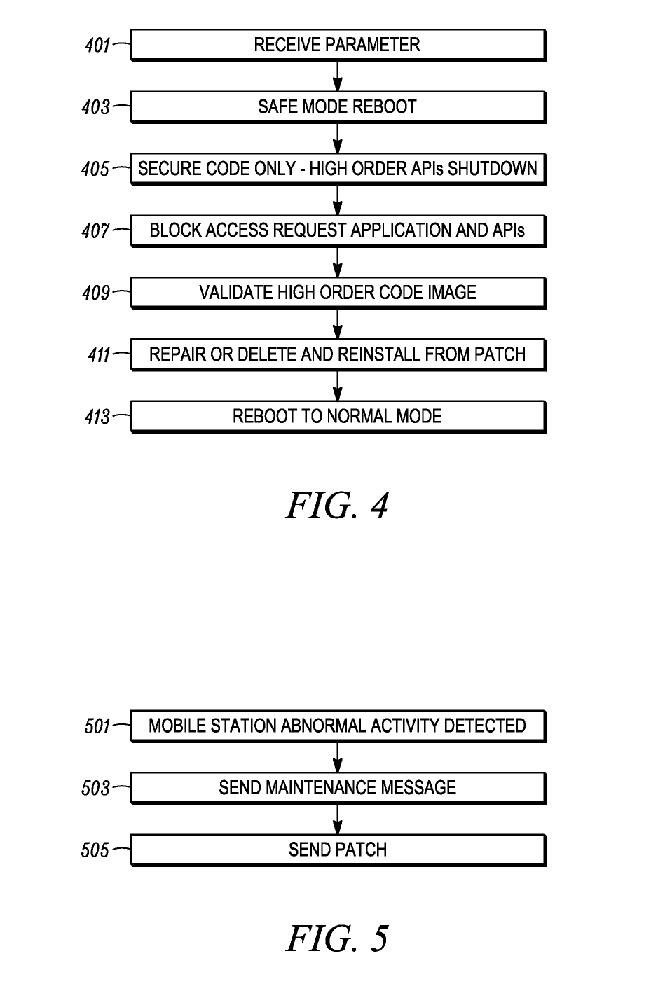

FIG. 4 illustrates the basic operation of the various embodiments. If a network detects an abnormality such as an undesirable number of access requests from a particular mobile station, then the network will send a maintenance message to the mobile station as shown in block 401. This message may be a simple physical layer indicator over the air interface as discussed previously. The message may also be a signed message using encryption. The mobile station will respond to the message by rebooting into safe mode as shown in block 403. In embodiments in which the maintenance message is signed, the mobile station will first verify the maintenance message authenticity, using for example certificate 231, and will verify the message integrity using an integrity key such as integrity key 227. In other embodiments, the maintenance message header information alone may be used for verifying authenticity, using again for example certificate 231. This approach, that is, verifying authenticity of header information, may also be used for verifying authenticity of software patches in some embodiments.

The integrity check may in some embodiments involve a one-way hash function, or further a data authentication code, in which the integrity key 227 is used to formulate the hash value. In such embodiments, the mobile station will use integrity key 227 to calculate the hash value for the received maintenance message. The mobile station will then compare the calculated hash value to a hash value which was sent along with the maintenance message. If the hash values match, the mobile station will assume that the maintenance message is uncorrupted and will proceed with further action.

Upon reboot, only secure code, which may correspond to the secure kernel 303 of FIG. 3, will operate while all other high order APIs will be shut down in block 405. These APIs may include, but are not limited to, APIs for object code, JAVA, Brew, Linux, Windows, HTML, WAP, script files including JavaScript, XML scripts, WML scripts, etc. The mobile station graphical display 225 may provide a user notification that the mobile station has entered into maintenance mode and may further provide an audible signal, such as, but not limited to, a specific tone or beep, via speaker 231.

Specifically in the various embodiments an AR application 315 and AR API 313 will be shutdown or blocked as shown in block 407. Further in some embodiments, the secure kernel 303 may validate the higher order code and APIs authenticity and integrity in block 409. For example, only signed code may be allowed to run in some embodiments provided its integrity has not been compromised. The damaged or altered code may be deleted, repaired, or reinstalled from a patch received by the network as shown in 411. The mobile station may then reboot back into normal operating mode as shown in block 413.

The base station, or base station controller, or network controller, will perform in accordance with FIG. 5 in the various embodiments. In block 501, the controlling entity, which may be base station 103 or base station controller 101, will determine that a particular mobile station is sending an undesirable number of access requests over the air interface. The base station 103 will then send maintenance message 503 having a parameter for causing the mobile station to reboot into safe mode. The parameter may also indicate a limitation for access requests from the mobile station, such as but not limited to, a limited number of allowable access requests for a given time period. As discussed, the maintenance message may be a physical layer indicator. The base station 103 may in some embodiments also send a software patch as shown in block 505.

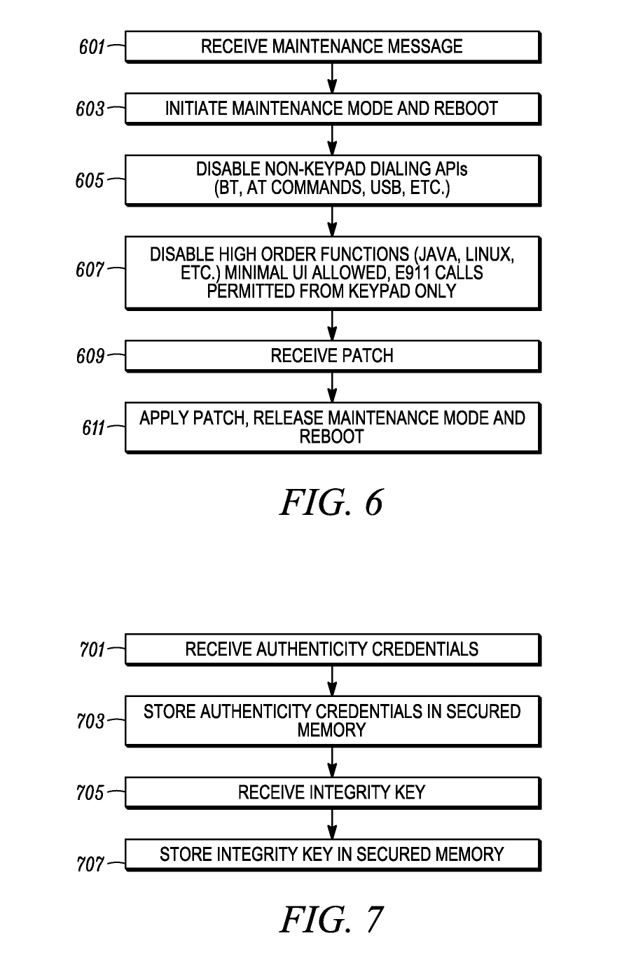

The mobile station receives the maintenance message in block 601 of FIG. 6. The mobile station will respond by rebooting into maintenance mode or safe mode in block 603. Upon rebooting, non-keypad dialing APIs including, but not limited to, Bluetooth™ (BT), AT commands, Universal Serial Bus (USB) etc. will be disabled as shown in block 605. Block 607 represents that all high order functions including, but not limited to, JAVA, Brew, Linux, Windows, HTML, WAP, script files including JavaScript, XML scripts, WML scripts, etc. will be disabled. However, in the various embodiments any application and APIs needed to allow keypad dialing of an emergency call, such as 911, are still permitted as shown in block 607.

In some embodiments, the network may also send a software patch, which is received by the mobile station in block 609. The mobile station may apply the patch and reboot into normal mode in block 611.

FIG. 7 illustrates the mobile station receiving and storing security information, such as authenticity credentials and integrity keys. In some embodiments, this process may occur as part of provisioning of the mobile station, that is, at some time prior to deployment of the mobile station in the field by a user. However, in other embodiments, the information may be sent to the mobile station over-the-air as illustrated in FIG. 1 wherein the mobile station 119 may receive integrity keys 117 and 117, and authenticity credentials 121 via communications link 113. Therefore, in FIG. 7, block 701, a mobile station receives authenticity credentials, which may include credentials for a maintenance message, and for various software patches. The mobile station stores the authenticity credentials in secured memory as shown in 703. The mobile station may also receive one or more integrity keys in block 705 and likewise store the integrity keys in secured memory as shown in block 707.

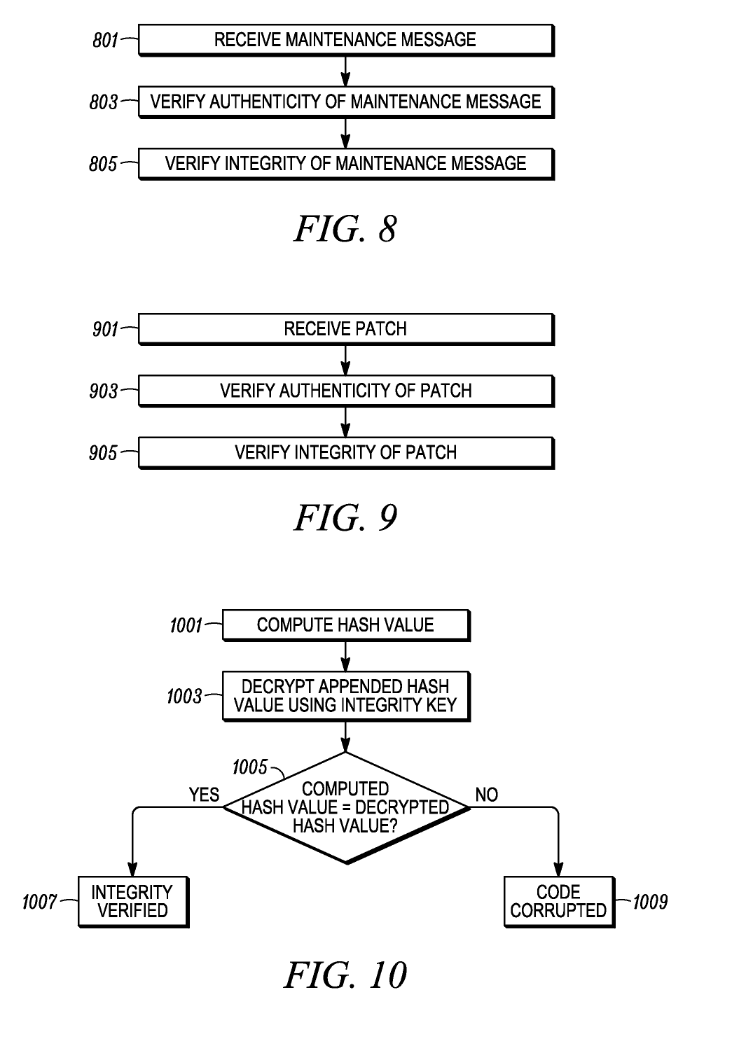

FIGS. 8 and 9 illustrate the mobile station general procedures for receiving a maintenance message and a software patch, respectively, in the various embodiments. In block 801, a maintenance message is received by the mobile station and is verified for authenticity in block 803. In block 805, the maintenance message is verified for integrity. Similarly, for any subsequently received software patches, received as shown in block 901, the mobile station verifies the patch authenticity in block 903, and verifies the patch integrity as shown in block 905. As previously discussed, the mobile station may store certificates, such as certificate 231, and integrity keys such as integrity keys 227 and 229, for use in verifying the maintenance message and software patch authenticity and integrity.

FIG. 10 provides further details of integrity verification of the maintenance message, and also for any subsequent software patches, for embodiments in which hash functions or data authentication codes are used. In such embodiments, a hash value will be sent along with the maintenance message or software patch. The mobile station will compute a hash value as shown in block 1001. The hash value sent along with the maintenance message or software patch is decrypted using an integrity key, for example integrity key 227 or 229, as shown in block 1003. The received hash value is compared to the computed hash value as shown in block 1005. If the received hash value matches the computed hash value, then the maintenance message or software patch integrity is assumed as shown in block 1007. If the hash values do not match, then the maintenance message or software patch is assumed invalid or corrupted as shown in block 1009. In the case of maintenance message verification failure, the mobile station will continue in its normal operating mode, until a valid maintenance message is received, in which case the mobile station will reboot into maintenance mode. In the case of software patch verification failure, the mobile station will continue operating in maintenance mode until a valid or uncorrupted software patch is received.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a wireless communication station, the method comprising:
receiving a maintenance message;
rebooting into a maintenance mode in response to said message; and
disabling non-keypad application programming interfaces upon said rebooting.

2. The method of claim 1, further comprising:
disabling all high order functions upon said rebooting.

3. The method of claim 1, further comprising:
receiving a software patch after said rebooting; and
releasing said maintenance mode using said software patch, and rebooting into a normal operating mode.

4. The method of claim 1, further comprising:
limiting access requests sent by said wireless communication station.

5. The method of claim 4, further comprising:
limiting access requests to a specified number of access requests over a limited time interval.

6. The method of claim 5, further comprising;
allowing access requests to exceed said specified number if an emergency number is entered via said keypad.

7. The method of claim 1, further comprising:
verifying authenticity of said maintenance message and verifying integrity of said maintenance message.

8. The method of claim 7, wherein said verifying integrity further comprises:
computing a first hash value corresponding to said maintenance message;
decrypting a second hash value appended to said maintenance message; and
verifying that said first hash value matches said second hash value.

9. The method of claim 1, wherein the step of disabling non-keypad application programming interfaces further comprises disabling a software stack and application programming interfaces corresponding to an unlicensed radio link, modem command capability, and serial bus capability.

10. The method of claim 9, wherein the step of disabling all high order functions further comprises disabling at least one of Java, Brew, or Linux application programming interfaces.

11. The method of claim 9 wherein said unlicensed radio link is one of Bluetooth, 802.11, IrDA, 802.16, or HomeRF.

12. The method of claim 11, wherein the step of disabling all high order functions further comprises disabling JavaScript.

13. The method of claim 1, wherein the step of rebooting into a maintenance mode in response to said message further comprises preventing unsigned code from executing.

14. The method of claim 3, further comprising:
verifying authenticity of said software patch and verifying integrity of said software patch.

15. The method of claim 14, wherein said verifying integrity of said software patch further comprises:
computing a first hash value corresponding to said software patch;
decrypting a second hash value appended to said software patch; and
verifying that said first hash value matches said second hash value.

16. A wireless communication station comprising:
a transceiver;
a processor coupled to said transceiver; and
a keypad coupled to said processor; said processor configured to:
process a maintenance message received at said transceiver;
reboot into a maintenance mode in response to said message; and
disable all application programming interfaces except application programming interfaces for said keypad upon said reboot.

17. The wireless communication station of claim 16, wherein said processor is further configured to disable all high order functions in response to said maintenance message.

18. The wireless communication station of claim 17, wherein said processor is further configured to:
apply a software patch received by said transceiver; and
release said maintenance mode upon applying said software patch and reboot into a normal operating mode.

19. The wireless communication station of claim 18, further comprising:
a secured memory component coupled to said processor, said secured memory component having at least one stored integrity key and at least one stored certificate.

20. The wireless communication station of claim 19, wherein said processor is further configured to:
verify authenticity of said maintenance message using said certificate and verify integrity of said maintenance message using said integrity key.

21. The wireless communication station of claim 20, wherein said processor is further configured to verify integrity of said maintenance message using said integrity key by decrypting a contained hash value contained in said maintenance message using said integrity key; computing a new hash value from said maintenance message; comparing said contained hash value to said new hash value and determining that said maintenance message integrity has been maintained if said contained hash value matches said new hash value.

22. The wireless communication station of claim 18, wherein said processor is further configured to: disable a software stack and application programming interfaces corresponding to an unlicensed radio link, modem command capability, and serial bus capability in response to said maintenance message.

23. The wireless communication station of claim 22, wherein said processor is further configured to disable at least one of Java, Brew, or Linux application programming interfaces.

24. The wireless communication station of claim 23, wherein said unlicensed radio link is one of Bluetooth, 802.11, IrDA, 802.16, or HomeRF.

25. The wireless communication station of claim 24, wherein said processor is further configured disable at least one of JavaScript or XML script.

26. The wireless communication station of claim -25, wherein said processor is further configured prevent unsigned code from executing while in maintenance mode.

27. A wireless communication station comprising:
a transceiver; and
a processor coupled to said transceiver, said processor configured to:
process a maintenance message having a parameter received at said transceiver;
reboot into a maintenance mode in response to said message; and
limit access requests send by said transceiver in accordance with said parameter.

28. The wireless communication station of claim 27, wherein said processor is further configured to:
limit how often over a period of time access requests may be sent by said transceiver in accordance with said parameter.

29. The wireless communication station of claim 28, wherein said processor is further configured to:
allow the transceiver to send access requests in excess of a limit specified by said parameter if an emergency call is being placed.

30. The wireless communication station of claim 29, further comprising a keypad coupled to said processor; wherein said processor is further configured to:
allow the transceiver to send access requests in excess of said limit specified by said parameter only if said emergency call is being placed from said keypad.
